(19) United States
(12) Patent Application Publication
(10) Pub. No.: US 2010/0082595 A1
(43) Pub. Date: Apr. 1, 2010

(54) Data Retrieving and Using Method and Device thereof

(76) Inventors: Tzung-I CHENG, Hsin Chu Hsien (TW); Chih-Cheng Chen, Hsin Chu Hsien (TW); Fu-Pao Shih, Hsin Chu Hsien (TW); Tsung-Yi Lu, Hsin Chu Hsien (TW); Meng-Tsung Hsieh, Hsin Chu Hsien (TW); Wei-Chen Chih, Hsin Chu Hsien (TW)

Correspondence Address: HDLS Patent & Trademark Services, P.O. BOX 220746, CHANTILLY, VA, 20153-0746, US

(21) Appl. No.: 12/329,773

(22) Filed: Dec. 8, 2008

(30) Foreign Application Priority Data
Sep. 22, 2008 (TW) 097136364

(51) Int. Cl. G06F 17/30

(52) U.S. Cl. 707/709; 707/E17.005

(57) ABSTRACT

A data retrieving and using method includes following steps: linking a designated website to obtain a corresponding webpage data, retrieving a specific key information of the corresponding webpage data by an information integrating module and/or an information integrating application software, and integrating the specific key information as an information demo zone and a hyperlink to a frame of a user interface.

### CROSS-REFERENCE TO RELATED APPLICATIONS

This application is based upon and claims the benefit of priority from the prior Taiwanese Patent Application No. 097136364, filed Sep. 22, 2008, the entire contents of which are incorporated herein by reference.

### BACKGROUND

1. Technical Field

The present invention relates to a technique of data collection, analysis and integration, and more particularly to a data retrieving and using method and a data retrieving and using device.

2. Description of the Related Art

In these days, as the pace of life continues to accelerate and the efficiency is required, it is urgently necessary that various receiving datum are classified, analyzed and integrated in every day. Therefore, how to receive and/or utilize job information, learning materials and entertainment information at the same time becomes an important topic, and with various electronic devices appearing at the market, requirement for integrating functions of various electronic devices comes into being necessary. Currently, some video player devices, such as digital photo frames can be connected to a remote device or a network server, the other can be connected to a specific network server (such as a blog server) to synchronize with the specific network server or display webpage datum of the specific network server. In addition, users can input letter datum or image datum to the digital photo frames by operating remote wireless input devices. For example, Taiwan patent no. M320874 discloses a digital photo frame that can provide timing information synchronized with a remote server. The digital photo frame includes a storage module, a network communication module and a data synchronization module. The network communication module is network connected to the remote server in a wired or wirelessly manner. The data synchronization module is used for making datum in the storage module synchronize with the remote server. Taiwan patent no. M328836 discloses a digital photo frame with a wireless input function. The digital photo frame includes a connecting port, a signal processing-controlling unit, a wireless transmitting module, an input controlling module, a display device and a display driving module. The connecting port is used for connecting with a storage device that stores image datum, or a provision device that provides the image datum. The display device with the help of the display driving module may display inputted image datum that are processed by the signal processing-controlling unit. The wireless transmitting module is used for transmitting/receiving wireless datum to/from a remote wireless input device. The input controlling module may control the remote wireless input device by the wireless transmitting module, so that the user may input letter datum or image datum to the digital photo frame by operating the remote wireless input device.

However, the above digital photo frame can be just connected to a single data source at a time and passively display the datum obtaining during a process of connection. Furthermore, the above digital photo frame is simply used as an auxiliary screen. In other word, the above digital photo frame displaying an image obtaining from the remote wireless input device is performed by converting an image on a main screen of the remote wireless input device to a single image file and then transmitting it to the above digital photo frame, and the above digital photo frame is just to achieve a simply displaying function. Therefore, the above digital photo frame is not easily to provide useful information that is diversified and accord with a specific need for busy people of today.

Therefore, what is desired is a new data retrieving and using method and device thereof.

### BRIEF SUMMARY

A data retrieving and using method is provided. The data retrieving and using method may integrate a plurality of information to a user interface, so that the user may obtain the diversified information from various websites conveniently.

The data retrieving and using method includes following steps: linking a designated website to obtain a corresponding webpage data, retrieving a specific key information of the corresponding webpage data by an information integrating module and/or an information integrating application software, and integrating the specific key information as an information demo zone and a hyperlink to a frame of a user interface.

In one embodiment of the present invention, the designated website, the specific key information, a search frequency, and a voice alert, a letter alert or an image alert, can be set and/or updated by a user. The user interface can be digital photo frame, a specific network server computer or a client computer. The corresponding webpage data, the specific key information or the frame can be transmitted and integrated to a video player device or a mobile device synchronously or asynchronously after being read from the storage device, so that the user may conveniently click and obtain specific information that the user requires.

A data retrieving and using device is also provided. The data retrieving and using device may link a designated website to obtain a corresponding webpage data, and retrieve a specific key word or image by an application software or module, and then integrate the specific key word or image to a predetermined location of the user interface as an information demo zone and a hyperlink. Therefore the user may browse what he requires conveniently, and further click the hyperlink and obtain detail information.

The data retrieving and using device includes a user interface, a transmitting module and an information integrating module and/or an information integrating application software. The transmitting module is wiredly or wirelessly connected to a designated website to obtain a corresponding webpage data. The information integrating module and/or the information integrating application software is used for retrieving a specific key information of the corresponding webpage data and integrating the specific key information as an information demo zone and a hyperlink to a frame of the user interface.

In another embodiment of the present invention, the data retrieving and using device further includes a storage device for storing the corresponding webpage data, the specific key information or the frame. The storage device can be a built-in storage device and/or an external storage device. The transmitting module and the information integrating module and/or the information integrating application software are used for transmitting and integrating the corresponding webpage data, the specific key information or the frame to a video player device or a mobile device synchronously or asynchronously after the corresponding webpage data, the specific key information or the frame is read from the storage device. The information integrating module and/or the information integrating application software can be used for setting a voice alert, a letter alert or an image alert. The information integrating module and/or the information integrating application software can be further configured to set and update a search frequency of the specific key information. The user interface can be a digital photo frame, a specific network server computer or a client computer. The data retrieving and using device further includes an input module provided for setting the designated website and the specific key information to the user interface by a user.

The data retrieving and using method and the data retrieving and using device of the present invention may integrate a plurality of information to a user interface, so that the user may obtain the diversified information from various websites conveniently. Therefore, the user may easily obtain the specific information for what he requires from the plurality of information.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a flow chart of a data retrieving and using method in accordance with an embodiment of the present invention.

FIG. 2 is a block diagram of a data retrieving and using device in accordance with an embodiment of the present invention.

### DETAILED DESCRIPTION

Reference will now be made to the drawings to describe various exemplary embodiments of the present data retrieving and using method and device thereof in detail.

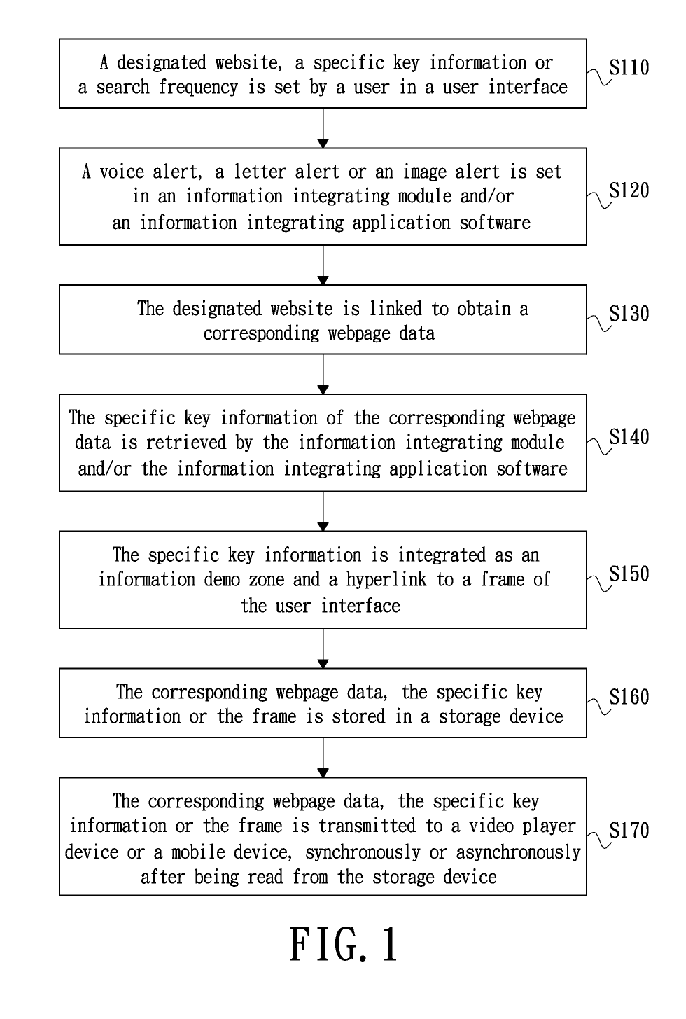

Referring to FIG. 1, a flow chart of a data retrieving and using method in accordance with an embodiment of the present invention is shown. A user interface employed in this embodiment is a digital photo frame for exemplary purposes, but may be other devices, such as a specific network server computer or a specific client computer. As shown in FIG. 1, in step S110, a user can set a designated website, a specific key information (such as a specific key word or image) or a search frequency (such as searching the designated website once a day or a week) in the user interface. It should be pointed out that, numbers of the designated website or the specific key information can be two or more, such that a plurality of data sources can be connected with the user interface and information from the plurality of data sources can be collected to a frame of the user interface. In step S120, a voice alert, a letter alert or an image alert can be set in an information integrating module and/or an information integrating application software, so that while finding and/or collecting the specific key information, a predetermined voice, color or image may appear. In step S130, the designated website is linked to obtain the corresponding webpage data. In step S140, the specific key information of the corresponding webpage data is retrieved by the information integrating module and/or the information integrating application software. In step S150, the specific key information is integrated as an information demo zone and a hyperlink to the frame of the user interface. The user interface can be a digital photo frame, a specific network server computer or a client computer. In step S160, the corresponding webpage data, the specific key information or the integrated frame is stored in a storage device. In step S170, the corresponding webpage data, the specific key information or the integrated frame is transmitted to a video player device or a mobile device, such as a computer screen, a mobile phone, a personal digital assistant (PDA) or a global position system (GPS), synchronously or asynchronously after being read from the storage device. In this way, the user can click straightly and obtain more detail information. In this embodiment, the storage device can be a built-in storage device and/or an external storage device. The built-in storage device can be a fixed disk (such as a hard disk) or a memory unit (such as RAM, DRAM or SRAM). The external storage device can be an external disk (such as an external hard disk), a portable disk (such as a pen drive) or memory card (such as a smart digital card).

In other embodiments, the data retrieving and using method further includes operating the user interface so as to output a controlling signal to the designated website, and update or click a corresponding webpage of the designated website. A content of the corresponding webpage can be meteorological information, stock exchange information or website news. In addition, the data retrieving and using method further includes performing the voice alert, the letter alert or the image alert in the user interface while obtaining the specific key information (such as an image or a sound about typhoon state).

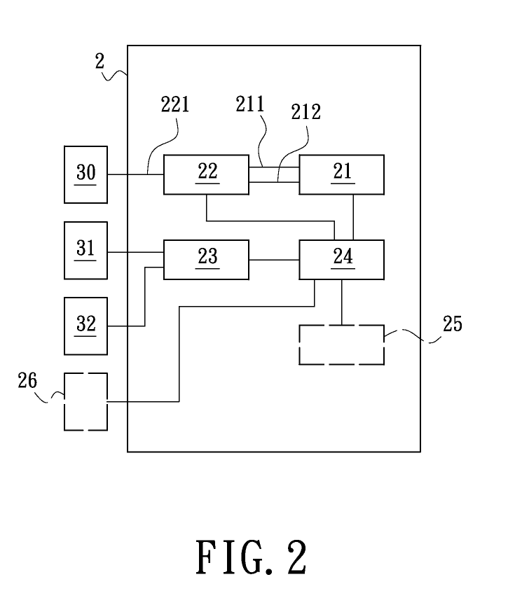

Referring to FIG. 2, a block diagram of a data retrieving and using device in accordance with an embodiment of the present invention is shown. As shown in FIG. 2, the data retrieving and using device 2 includes an input module 21, a user interface 22, a transmitting module 23, an information integrating module 24, a built-in storage device 25 and/or an external storage device 26. It should be pointed out that, according to a design requirement, the data retrieving and using device 2 can have either one of the built-in storage device 25 and the external storage device 26, or both of them at the same time, and in this regard, the built-in storage device 25 and the external storage device 26 are indicated by broken lines in FIG. 2. In this embodiment, the input module 21 is provided for a user setting a designated website 211 and a specific key information 212 to the user interface 22. The user interface 22 can be a digital photo frame, a specific network server computer or a client computer. The user interface 22 can play a common frame, or a frame and a sound signal with the specific key information. The user interface 22 can further be configured to output a controlling signal 221 to a data resource 30 corresponding to the designated website, and update or click a corresponding webpage of the designated website.

The information integrating module 24 is used for retrieving and integrating the specific key information of the corresponding webpage data. According to a design requirement of a hardware or software, the information integrating module 24 can be used by itself or with an information integrating application software (now shown). The transmitting module 23 and the information integrating module 24 and/or the information integrating application software can transmit and integrate the corresponding webpage data, the specific key information or the frame to a video player device 31 or a mobile device 32 synchronously or asynchronously after the corresponding webpage data, the specific key information or the frame is read from the built-in storage device 25 and/or the external storage device 26. In other embodiments, the information integrating module 24 and/or the information integrating application software cooperating with the input module 21 and the user interface 22 can further be configured to set and update a search frequency of the specific key information; and the information integrating module 24 and/or the information integrating application software can further be configured to set a voice alert, a letter alert or an image alert therein, and the voice alert, the letter alert or the image alert is performed in the user interface 22 while obtaining the specific key information 212.

The built-in storage device 25 and/or the external storage device 26 are the storage device of the data retrieving and using device 2. The built-in storage device 25 can be a fixed disk (such as a hard disk) or a memory unit (such as RAM, DRAM or SRAM). The external storage device 26 can be an external disk (such as an external hard disk), a portable disk (such as a pen drive) or a memory card (such as a smart digital card). The information integrating module 24 and/or the information integrating application software can asynchronously transmit and integrate the corresponding webpage data, the specific key information or the frame to a video player device 31 or a mobile device 32 via the transmitting module 23, after the corresponding webpage data, the specific key information or the frame is read from the built-in storage device 25 and/or the external storage device 26.

In summary, the data retrieving and using method and the data retrieving and using device of the present invention are set to link the designated website to obtain the corresponding webpage data, and the information integrating module and/or the information integrating application software can retrieve the specific key information of the corresponding webpage data and integrate the specific key word or image as the information demo zone and the hyperlink to the frame or the predetermined location of the user interface. Therefore, the data retrieving and using method and device thereof of the present invention may easily integrate various information to a single user interface, or distribute the various information in a plurality of user interfaces synchronously or asynchronously. As a result, by using the data retrieving and using method and the data retrieving and using device of the present invention, the user may browse and obtain the diversified information conveniently.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A data retrieving and using method comprising:
linking a designated website to obtain a corresponding webpage data,
retrieving a specific key information of the corresponding webpage data by an information integrating module and/or an information integrating application software, and
integrating the specific key information as an information demo zone and a hyperlink to a frame of a user interface.

2. The data retrieving and using method according to claim 1, further comprising storing the corresponding webpage data, the specific key information or the frame in a storage device.

3. The data retrieving and using method according to claim 2, further comprising transmitting and integrating the corresponding webpage data, the specific key information or the frame to a video player device or a mobile device synchronously or asynchronously after the corresponding webpage data, the specific key information or the frame is read from the storage device.

4. The data retrieving and using method according to claim 2, wherein the storage device is a built-in storage device and/or an external storage device.

5. The data retrieving and using method according to claim 4, wherein the built-in storage device is one of a fixed disk or a memory unit, and the external storage device is one of an external disk, a portable disk or a memory card.

6. The data retrieving and using method according to claim 1, further comprising setting and updating a search frequency of the specific key information.

7. The data retrieving and using method according to claim 1, further comprising operating the user interface so as to output a controlling signal to the designated website, and update or click a corresponding webpage of the designated website.

8. The data retrieving and using method according to claim 1, wherein the designated website and the specific key information are set in the user interface by a user.

9. The data retrieving and using method according to claim 1, wherein the user interface is a digital photo frame, a specific network server computer or a client computer.

10. The data retrieving and using method according to claim 1, further comprising setting a voice alert, a letter alert or an image alert in the information integrating module and/or the information integrating application software, and performing the voice alert, the letter alert or the image alert in the user interface after obtaining the specific key information.

11. A data retrieving and using device comprising:
a user interface,
a transmitting module wiredly or wirelessly connected to a designated website to obtain a corresponding webpage data, and
an information integrating module and/or an information integrating application software for retrieving a specific key information of the corresponding webpage data and integrating the specific key information as an information demo zone and a hyperlink to a frame of the user interface.

12. The data retrieving and using device according to claim 11, further comprising a storage device for storing the corresponding webpage data, the specific key information or the frame.

13. The data retrieving and using device according to claim 12, wherein the storage device is a built-in storage device and/or an external storage device.

14. The data retrieving and using device according to claim 13, wherein the built-in storage device is one of a fixed disk or a memory unit, and the external storage device is one of an external disk, a portable disk or a memory card.

15. The data retrieving and using device according to claim 13, wherein the transmitting module and the information integrating module and/or the information integrating application software are used for transmitting and integrating the corresponding webpage data, the specific key information or the frame to a video player device or a mobile device synchronously or asynchronously after the corresponding webpage data, the specific key information or the frame is read from the built-in storage device and/or the external storage device.

16. The data retrieving and using device according to claim 11, wherein the information integrating module and/or the information integrating application software is further configured to set and update a search frequency of the specific key information.

17. The data retrieving and using device according to claim 11, wherein the user interface is further configured to output a controlling signal to the designated website, and update or click a corresponding webpage of the designated website.

18. The data retrieving and using device according to claim 11, further comprising an input module provided for setting the designated website and the specific key information to the user interface by a user.

19. The data retrieving and using device according to claim 11, wherein the user interface is a digital photo frame, a specific network server computer or a client computer.

20. The data retrieving and using device according to claim 11, wherein the information integrating module and/or the information integrating application software is used for setting a voice alert, a letter alert or an image alert, and the voice alert, the letter alert or the image alert is performed in the user interface while the specific key information is obtained.
